(19) United States
(12) Patent Application Publication
(10) Pub. No.: US 2016/0066689 A1
(43) Pub. Date: Mar. 10, 2016

(54) DEVICE FOR THE SUPPORT AND SAFE MOVEMENT OF CABINET DOORS

(71) Applicant: TERNO SCORREVOLI s.r.I., Varedo (MB) (IT)

(72) Inventor: Giovanni TERNO, Varedo (MB) (IT)

(21) Appl. No.: 14/812,905

(22) Filed: Jul. 29, 2015

(30) Foreign Application Priority Data
Sep. 9, 2014 (IT) MI2014A001554

(51) Int. Cl. A47B 96/00; E05D 15/06

(52) U.S. Cl. CPC A47B 96/00; E05D 15/0608; E05D 15/063; E05D 15/0652

(57) ABSTRACT

The invention relates to an improved device for the support and safe movement of doors (12-12) of cabinets (10), wherein such doors are movable from a closed condition which defines the total alignment thereof, to an open position in which they are, alternatively conducted to protrude forward to then be moved open by longitudinal sliding surmounting those adjacent to them. Said device is coupled to the top of the cabinet (10) and comprises, for each of said doors, a plurality of wheels or bearings with a vertical orientation (14,16), arranged on two different horizontal lines defined by metal sections, with the wheels (14) arranged so as to freely rotate inside a fixed frame or drum (18) and the wheels (16) rotatably fixed to a section (20) belonging to a carriage fixed to each door (12, 12′). Said section and relative carriage are movable in a transverse direction to conduct said wheels (14) to align with the wheels (16) on a single sliding line.

The device of the invention comprises a safety mechanism (22) provided with a control lever (24), fixed to the front face of the section (20) on the same plane as the wheels (16), and a shaped plate (26) with a function of guiding cam for a guide wheel (28), arranged in the lower part of said lever (24) and projecting from the lower edge of said section (20).

The present invention relates to an improved device for the support and safe movement of cabinet doors.

More particularly, the present invention relates to a device suitable to support and slidingly move, in opening and closing, cabinet doors; said latter are provided with carriages with wheels or bearings and move linearly and transversely along guides or sliding tracks, typically made from shaped metal sections fixed to the upper part and the lower part of said cabinets. In the device of the present invention, the transverse movement, perpendicular to the linear sliding, makes it possible to keep all the doors closed on a single plane.

As is known, cabinets can be provided with doors with cantilever opening using hinges, or with doors with carriages sliding on dedicated rails, which offer the advantage of not causing obstruction in the environment when open. According to the latter solution, the doors are arranged on two parallel planes, alternating with each other so that all of them can be opened without interfering with each other; two pairs of guides sliding along the front edge of the cabinets, either at the top or the bottom are consequently provided. This structural configuration, although functionally valid, has the drawback of not allowing a coplanar arrangement of the doors when closed, given that they remain obligatorily alternated on two different planes, one more outwardly positioned than the other; at least in aesthetic terms it would instead be preferable for all the doors to be arranged, when closed, on one single plane. Especially in the case in which the cabinet occupies an entire wall of a room, as is often the case, the coplanarity of all the doors is particularly appreciated.

Some specific solutions have been devised to cater to this need which make it possible to move part of the doors in two directions orthogonal to each other so as to pass from a condition of coplanarity of all the doors closed to a condition in which one or more of them are temporarily led to project in a cantilever so as to be opened by sliding without problems, surmounting the adjacent ones. Examples of this solution are found in EP 1388632 and in WO 2013/178240 which the applicant is the owner of. Both patents in fact relate to a device for doors or sliding doors of cabinets which make it possible to obtain the coplanarity of said doors once closed. This is achieved through the presence of individual sections fixed to the top of the cabinet, at each door, and respective carriages with wheels fixed to the individual doors; said carriages comprise both wheels aligned with each other, for the longitudinal sliding of the doors, and opposite end wheels, oriented orthogonally with respect to the former for the movement in a transversal direction of said doors. A further couple of paired wheels is fixed as a guide on the lower floor of the carriage. The movement in the transverse direction of the doors is performed with the assistance of a transverse section, sliding along opposite rollers on which a helical groove is made; two pins coming out of said section engage in the latter. In the opposite lower part skates with notches and rollers are provided in order to obtain a corresponding cantilevered movement of the individual doors, with an angular section fixed to the lower part of each door.

It has, furthermore, been found that even these solutions, although functioning, have some significant drawbacks, both during the engagement of the carriages of the doors to the respective supports and during their longitudinal sliding along the corresponding guide. In fact, in the moment in which the door with its carriage and relative wheels or bearings is coupled to the upper part of the cabinet said wheels need to be aligned with those present on the fixed part, i.e. matched with the section integral with the top of the cabinet; if the alignment is not exact, the door may rest only on a part of the wheels, in particular those of the fixed part, with the risk of falling and, in any case, not working properly in terms of movement. Moreover, even in the case in which the coupling is carried out correctly, with all the wheels or bearings aligned with each other, an appreciable swaying of the door during sliding is frequently seen, given that the support with wheels attached to it lacks abutments and is therefore free to deviate from the ideal position. If then the user were to accidentally push the door back before making it slide open, once arrived at the end stroke it could uncouple given that it lacks the support of the wheels attached to it.

The purpose of the present invention is to overcome the drawbacks complained of above.

More particularly, the purpose of the present invention is to provide an improved device for the support and safe movement of cabinet doors suitable to stabilise the door to be coupled to the cabinet in any condition and to determine, consequently, its attachment only in the correct position, i.e. above all the wheels or bearings aligned with each other.

A further object of the invention is to provide a device as defined above suitable to allow an optimum movement of the individual doors on opening, protected from obvious swaying phenomena and thus accompanied by annoying noises due to their linear sliding.

A further, no less important purpose of the invention is to provide a device for the support and safe movement of cabinet doors suitable to prevent the frame with carriage attached to each door from being accidentally moved by the user, with the risk of altering the correct sliding position.

A further purpose of the invention is to make available to users a device for the support and movement of cabinet doors suitable to ensure a high level of resistance and reliability over time, in addition such as to be easily and economically made.

These and other purposes are achieved by the improved device for the support and safe movement of cabinet doors of the present invention, according to the main claim.

The construction and functional characteristics of the improved device for the support and safe movement of cabinet doors of the present invention will be more clearly comprehensible from the detailed description below in which reference is made to the appended drawings which show a preferred and non-limiting embodiment and wherein:

FIG. 1 schematically represents, in perspective, a cabinet with two doors by way of example fitted with the device of the invention, in which one of said doors is cantilevered forward compared to the other so as to slide in a longitudinal direction;

FIG. 2 schematically represents, in perspective, from the front face, a cabinet with two doors by way of example, fitted with the device for the support and safe movement of the present invention;

FIG. 3 is an enlargement of the previous figure, to highlight part of the mentioned device of the invention;

FIG. 4 schematically represents, in an exploded view, a lever constituting the safety mechanism applied to the device of the invention;

FIG. 5 schematically represents, in perspective, the same lever assembled in its components and constrained to the carriage made integral with each of the doors;

FIG. 6 schematically represents, in partial perspective, said lever joined to a shaped plate that forms the guide cam;

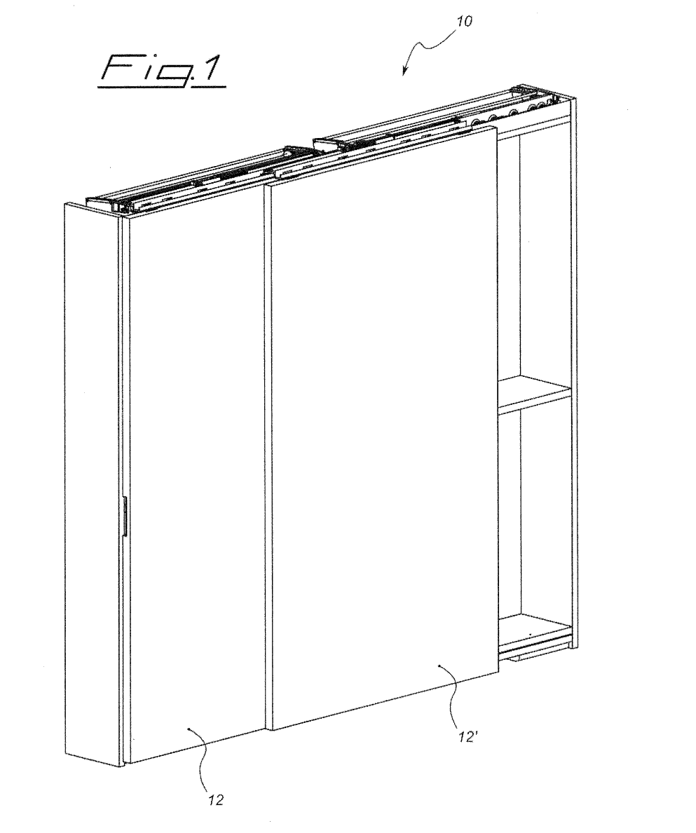

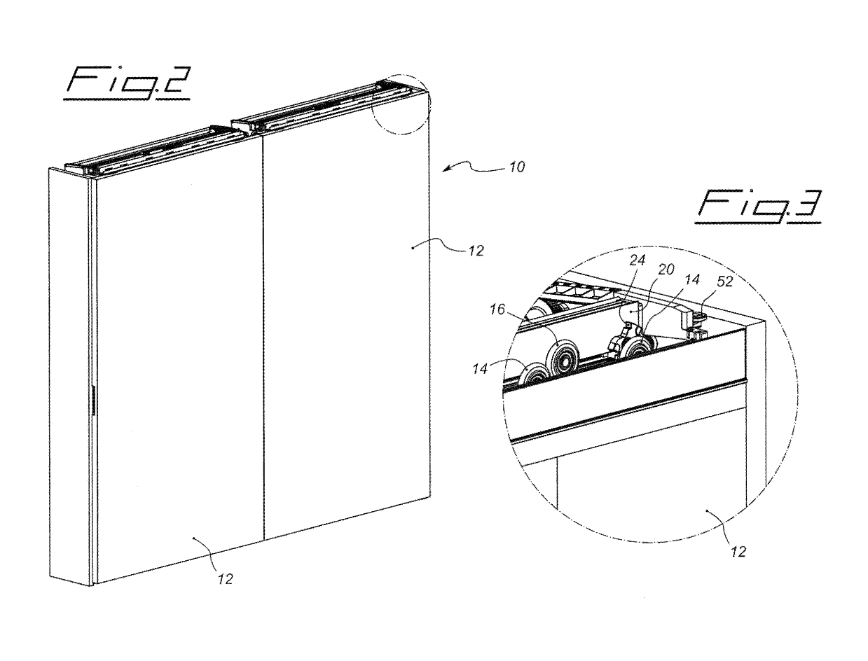

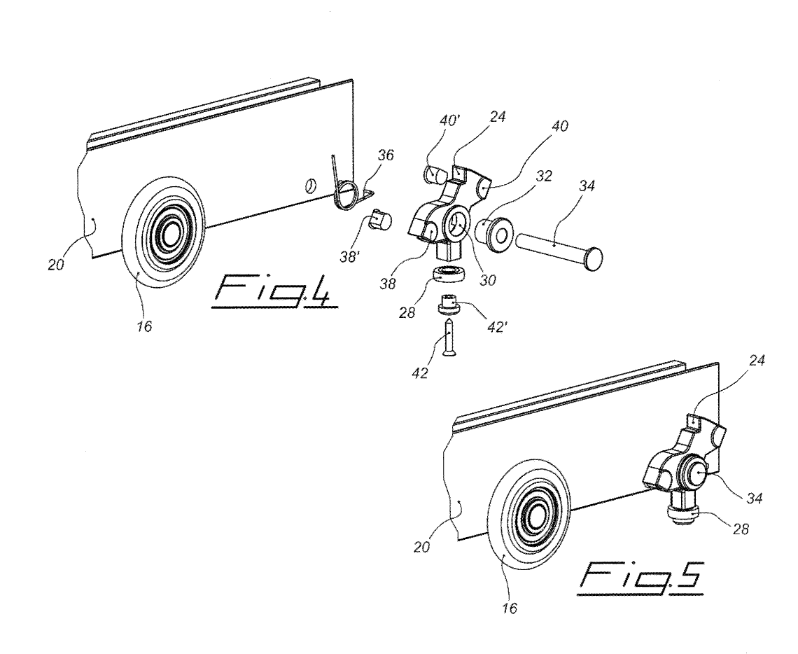

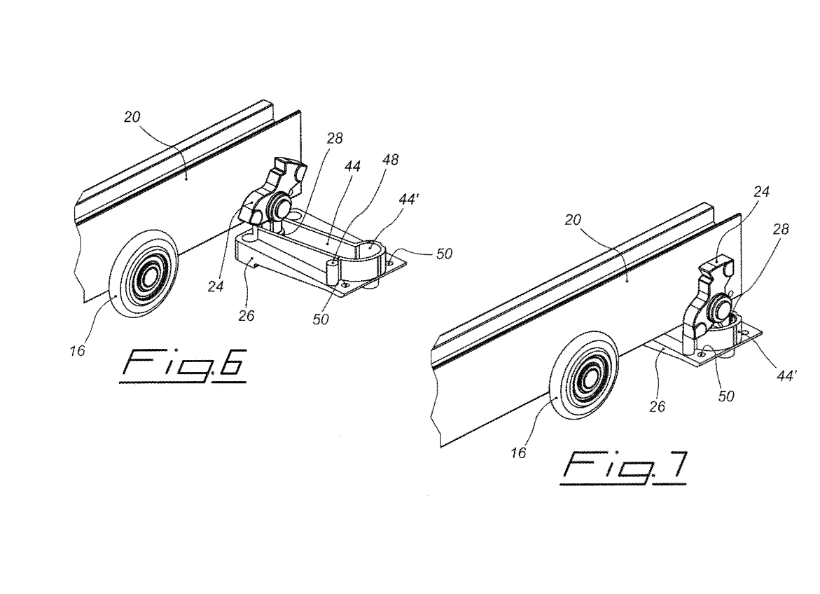

FIG. 7 schematically represents, in perspective, the lever constituting the safety mechanism in the position of greatest advancement in the guide cam;

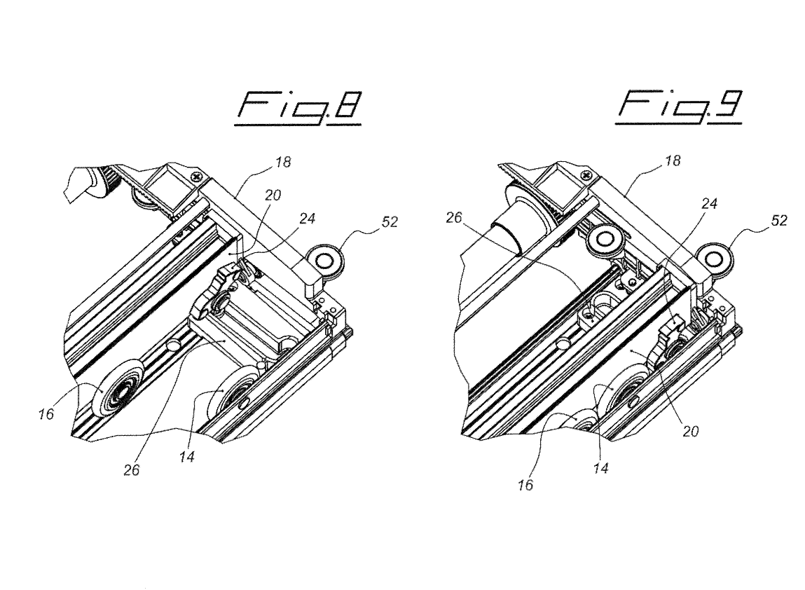

FIG. 8 schematically represents , in schematic view from above, part of the device of the invention, to highlight the arrangement of the wheels or bearings on two different lines, corresponding to the situation where the door is aligned in closing with all the others and therefore cannot be opened;

FIG. 9 schematically represents , in schematic view from above, the same part of the device of the invention, to highlight the alignment of the wheels or bearings on a single line corresponding to the situation in which the door is cantilevered forward compared to the others to be able to slide open longitudinally.

With initial reference to figures from 1 to 3, the improved device for the support and safe movement of cabinet doors of the present invention is applied to each door, 12 12′ of a cabinet 10 at the flat upper part which defines the top and the lower bottom next to or coincident with the front edge. Said device is preferably though not critically suitable for integrating the solutions described in EP1.388.632 and/or in WO/2013 178240, referring to support and movement apparatuses for cabinet doors sliding longitudinally along upper and lower guides and which are also movable at right angles to the longitudinal direction, to maintain perfect coplanarity once conducted into the closed position. The aforesaid FIG. 1 illustrates the example of a cabinet with two doors, one of which, denoted by reference numeral 12′, cantilevered outwards so as to be conducted to slide open leaving the other in an unchanged position. FIG. 2 illustrates in perspective the cabinet 10 with the two doors coplanar with each other and both indicated by reference numeral 12; from the upper face with a planar extension a part of the device of the invention can be seen, better highlighted in the magnification of FIG. 3. On the latter, in particular, wheels or bearings with a vertical orientation, 14, 16 can be seen, arranged on two different horizontal lines defined by metal sections illustrated in more detail in FIGS. 6 to 9. The wheels 14 are arranged so as to freely rotate inside a fixed frame or drum 18, while the wheels 16 are rotatably fixed to a section 20 of the carriage fixed to each door 12, 12′. Said section and relative carriage, according to the teaching of the aforementioned patents, can move in a transverse direction to conduct the wheels 14 to align with the wheels 16 on a single sliding line, thereby determining the cantilevered positioning of one of the aforementioned doors, in particular of the door 12′ in relation to the other door 12.

According to the invention, in order to ensure the precise alignment of the wheels 14, 16 during assembly of the doors 12, 12′ and to prevent unwanted and potentially dangerous movements of the section 20 with wheels 16 with respect to the fixed frame 18, the use of a safety mechanism globally denoted by reference numeral 22 in FIG. 6, is provided for. Said mechanism comprises a control lever 24 fixed to the front face of the section 20 on the same plane as the wheels 16, and a shaped plate 26 with a guide cam function for the lever 24, in particular for a guide wheel 28 placed in the lower part of said lever and projecting from the lower edge of said section 20. The safety lever 24 shown in detail in FIGS. 4 and 5, consists of an irregular prismatic body with a tendentially “S” shaped profile, provided with a transversal hole 30 is which a rivet 34 is inserted, preferably with the interposition of a bushing 32 suitable to constrain said lever to the section 20. Said lever 24, which is combined with a safety torsion spring 36, comprises two sunken seats, 38 40 in which rubber cushions 38′ 40′ are fixed with adhesives or equivalent means, suitable to dampen and silence respectively the abutment of said lever on the shaped plate 26.

The guide wheel 28 mentioned is attached to the bottom of the safety lever with a screw 42 and a bushing 42′. Said guide wheel, as seen in particular in FIGS. 6 and 7, is designed to fit and slide in a seat 44 which substantially defines the stroke of the lever 24 during the excursion in a transverse direction, forward or backward, of each door 12 or 12′ to conduct the wheels 14, 16 on a single line or on two different lines. In the first case the doors are in alignment, in the second case one of them will be cantilevered in relation to the other in order to then be conducted to slide open longitudinally. The seat 44 made on the plate 26 is delimited by parallel walls that, at the front end opposite the mouth, form a connection portion 44′ with a substantially semi-circular extension; the rubber cushions 38′ conveniently dampen the abutment of the lever 24 on a pin 48 , projecting from the shaped plate 26 and constituting the end stroke of said lever. FIGS. 6 and 7 show, in particular, the movement that the lever 24 makes in the seat 44, with the guide wheel 28 which comes to position itself in the portion 44′ with a substantially semi-circular extension, bringing said lever into a vertical position.

Said plate 26 is provided with holes 50 for fixing it with screws in the fixed frame or drum 18, below the section 20. This way, the safety mechanism 22 comprising the safety lever 24 forms a stabilisation and guide bridge for the section 20 during its movement forward or backward and prevents possible swaying during sliding of the door.

According to a further advantageous characteristic of the invention, on the sides of the frame 18, on opposite sides of the cabinet defining its depth, at least one additional, freely rotating bearing with horizontal orientation is cantilever fixed; said bearing, as seen in particular in FIG. 3, in rolling abuts with the inner edge of the roof portion corresponding to each door 12 or 12′ at the moment in which the section 20 of the moving carriage is conducted to advance or retreat. This guarantees linearity in the sliding of the carriage, avoiding possible jumps which may give rise not just to malfunction, but also determine noise.

As may be seen from the above, the advantages which the invention achieves are evident.

The improved device of the present invention makes it possible to support and move cabinet doors safely, allowing the user to easily arrange them in a coplanar or open position, without running into the problems encountered in the prior solutions of this kind and typically associated with the possibility of incorrect coupling of the said doors, consequent possible swaying or, even worse, uncoupling from the relative seat.

Despite the invention having been described above with reference to one of its possible embodiments, given solely by way of a non-limiting example, numerous modifications and variants will appear evident to a person skilled in the art in the light of the above description. The present invention therefore sets out to embrace all the modifications and variants which fall within the sphere and scope of the following claims.

1) An improved device for the support and safe movement of doors (12-12′) of cabinets (10), wherein such doors are movable from a closed condition which defines the total alignment thereof to an open position and in which they are, alternatively conducted to protrude forward to then be moved open by longitudinal sliding surmounting those adjacent to them, said device being coupled to the top of the cabinet (10) and comprising, for each of said doors, a plurality of wheels or bearings with a vertical orientation (14,16), arranged on two different horizontal lines defined by metal sections, with the wheels (14) arranged so as to freely rotate inside a fixed frame or drum (18) and the wheels (16) rotatably fixed to a section (20) belonging to a carriage fixed to each door (12, 12′), said section and relative carriage being movable in a transverse direction to conduct said wheels (14) to align with the wheels (16) on a single sliding line, characterised in that it comprises a safety mechanism (22) provided with a control lever (24), fixed to the front face of the section (20) on the same plane as the wheels (16), and a shaped plate (26) with a function of guiding cam for a guide wheel (28), arranged in the lower part of said lever (24) and projecting from the lower edge of said section (20).

2) The device according to claim 1, characterised in that said safety lever (24) consists of an irregular prismatic body with a tendentially “S” shaped profile, provided with a transversal hole (30) which houses with the interposition of a bushing (32) a rivet (34) suitable to constrain said lever to the section (20).

3) The device according to claim 2, characterised in that the safety lever (24) is combined with a safety torsion spring (36), said lever (24) being provided with two sunken seats (38, 40) in which rubber cushions (38′, 40′) are fixed suitable to dampen and silence respectively the abutment of said lever on the shaped plate (26).

4) The device according to claim 1, characterised in that the guide wheel (28) is fixed to the lower part of said lever (24) by a screw (42) or equivalent with the interposition of a bushing (42′), said wheel being inserted and sliding in a seat (44) which substantially defines the stroke of the lever (24) during the excursion in a transverse direction of each door (12) or (12′).

5) The device according to claim 4, characterised in that said seat (44) made on the plate (26) is delimited by parallel walls that, at the front end opposite the mouth which the guide wheel (28) fits into, form a connection portion (44′) with a substantially semi-circular extension.

6) The device according to claim 5, characterised in that from the shaped plate (26) a pin (48) protrudes constituting the end stroke of the safety lever (24).

7) The device according to claim 1, characterised in that said plate (26) is provided with holes (50) for its attachment with screws in the fixed frame or drum (18) under the section (20).

8) The device according to claim 7, characterised in that on the sides of the frame (18), on opposite sides of the cabinet (10) defining its depth, at least one additional freely rotating bearing (52) with horizontal orientation is cantilever fixed suitable to abut with the inner edge of the roof portion corresponding to each door (12) or (12′).

9) The device according to claim 2, characterised in that said plate (26) is provided with holes (50) for its attachment with screws in the fixed frame or drum (18) under the section (20).

10) The device according to claim 9, characterised in that on the sides of the frame (18), on opposite sides of the cabinet (10) defining its depth, at least one additional freely rotating bearing (52) with horizontal orientation is cantilever fixed suitable to abut with the inner edge of the roof portion corresponding to each door (12) or (12′).

11) The device according to claim 3, characterised in that said plate (26) is provided with holes (50) for its attachment with screws in the fixed frame or drum (18) under the section (20).

12) The device according to claim 11, characterised in that on the sides of the frame (18), on opposite sides of the cabinet (10) defining its depth, at least one additional freely rotating bearing (52) with horizontal orientation is cantilever fixed suitable to abut with the inner edge of the roof portion corresponding to each door (12) or (12′).

13) The device according to claim 4, characterised in that said plate (26) is provided with holes (50) for its attachment with screws in the fixed frame or drum (18) under the section (20).

14) The device according to claim 13, characterised in that on the sides of the frame (18), on opposite sides of the cabinet (10) defining its depth, at least one additional freely rotating bearing (52) with horizontal orientation is cantilever fixed suitable to abut with the inner edge of the roof portion corresponding to each door (12) or (12′).

15) The device according to claim 5, characterised in that said plate (26) is provided with holes (50) for its attachment with screws in the fixed frame or drum (18) under the section (20).

16) The device according to claim 15, characterised in that on the sides of the frame (18), on opposite sides of the cabinet (10) defining its depth, at least one additional freely rotating bearing (52) with horizontal orientation is cantilever fixed suitable to abut with the inner edge of the roof portion corresponding to each door (12) or (12′).

17) The device according to claim 6, characterised in that said plate (26) is provided with holes (50) for its attachment with screws in the fixed frame or drum (18) under the section (20).

18) The device according to claim 17, characterised in that on the sides of the frame (18), on opposite sides of the cabinet (10) defining its depth, at least one additional freely rotating bearing (52) with horizontal orientation is cantilever fixed suitable to abut with the inner edge of the roof portion corresponding to each door (12) or (12′).

19) An improved device for the support and safe movement of doors (12-12′) of cabinets (10), wherein such doors are movable from a closed condition which defines the total alignment thereof to an open position and in which they are, alternatively conducted to protrude forward to then be moved open by longitudinal sliding surmounting those adjacent to them, said device being coupled to the top of the cabinet (10) and comprising, for each of said doors, a plurality of wheels or bearings with a vertical orientation (14,16), arranged on two different horizontal lines defined by metal sections, with the wheels (14) arranged so as to freely rotate inside a fixed frame or drum (18) and the wheels (16) rotatably fixed to a section (20) belonging to a carriage fixed to each door (12, 12′), said section and relative carriage being movable in a transverse direction to conduct said wheels (14) to align with the wheels (16) on a single sliding line, characterised in that it comprises a safety mechanism (22) provided with a control lever (24), fixed to the front face of the section (20) on the same plane as the wheels (16), and a shaped plate (26) with a function of guiding cam for a guide wheel (28), arranged in the lower part of said lever (24) and projecting from the lower edge of said section (20), said control lever (24) consisting of an irregular prismatic body and being combined with a safety torsion spring (36), with a device to constrain said lever (24) to the section (20).

20) An improved device for the support and safe movement of doors (12-12′) of cabinets (10), wherein such doors are movable from a closed condition which defines the total alignment thereof to an open position and in which they are, alternatively conducted to protrude forward to then be moved open by longitudinal sliding surmounting those adjacent to them, said device being coupled to the top of the cabinet (10) and comprising, for each of said doors, a plurality of wheels or bearings with a vertical orientation (14,16), arranged on two different horizontal lines defined by metal sections, with the wheels (14) arranged so as to freely rotate inside a fixed frame or drum (18) and the wheels (16) rotatably fixed to a section (20) belonging to a carriage fixed to each door (12, 12′), said section and relative carriage being movable in a transverse direction to conduct said wheels (14) to align with the wheels (16) on a single sliding line, characterised in that it comprises a safety mechanism (22) provided with a control lever (24), fixed to the front face of the section (20) on the same plane as the wheels (16), and a shaped plate (26) with a function of guiding cam for a guide wheel (28), arranged in the lower part of said lever (24) and projecting from the lower edge of said section (20), said guide wheel (28) being fixed to the lower part of said control lever (24), and said guide wheel (28) being inserted and sliding in a seat (44) which substantially defines the stroke of the lever (24) during excursion in a transverse direction of each door (12) or (12′).
